(19) United States
(12) Patent Application Publication
(10) Pub. No.: US 2014/0130966 A1
(43) Pub. Date: May 15, 2014

(54) CIRCUIT COMPRISING A COMPONENT COVERED WITH A LID, METHOD FOR PRODUCING SUCH A CIRCUIT, AND DEVICE FOR IMPLEMENTING SAID METHOD

(71) Applicants: Sebastien Brault, Marcoussis (FR); Elisabeth Dufour-Gergam, Fontenay Sous Bois (FR); Fabrice Verjus, Creully (FR); Martiel Desgeorges, Marcoussis (FR)

(72) Inventors: Sebastien Brault, Marcoussis (FR); Elisabeth Dufour-Gergam, Fontenay Sous Bois (FR); Fabrice Verjus, Creully (FR); Martiel Desgeorges, Marcoussis (FR)

(73) Assignee: KFM TECHNOLOGY, Villebon-Sur-Yvette (FR)

(21) Appl. No.: 13/992,510

(22) PCT Filed: Dec. 8, 2011
(86) PCT No.: PCT/FR11/52900

§ 371 Date: Jan. 16, 2014

(30) Foreign Application Priority Data
Dec. 8, 2010 (FR) 1060259

(51) Int. Cl. B29C 65/48; B29C 65/00

(52) U.S. Cl. CPC B29C 65/48; B29C 66/001
USPC 156/228; 156/581

(57) ABSTRACT

The invention relates to an electronic circuit (1) consisting of a substrate (10) having a surface on which at least one component (3) covered with a lid (22) is mounted. Said component comprises first connection means (15) to be connected to second connection means (70). In said circuit (1), at least one connection passage (50) is provided that extends through the lid in order to link the first connection means (15) to the outside of the lid, which then makes it possible to link the first means to the second connection means (70) (see FIG. 2). The invention can be used for the production of microsystems that require the encapsulation of some components.

This invention relates to an electronic circuit consisting of a substrate with at least one face on which at least one component is mounted with which first connection means are linked, and at least one lid resting on said substrate in order to cover said component.

The invention also relates to a method for encapsulating a component or for placing the latter under a lid, which component is intended for such a circuit, and a device for implementing this method.

The invention applies in particular to the microsystem needing components such as sensors that require protection from the outside or at least some insulation from the environment.

Patent document WO 2010/012966 describes a method for encapsulation of components for such circuits. Although the method described is entirely satisfactory, it does not respond to all of the configurations that might be envisaged.

The invention aims to provide measures to enable some flexibility in order to establish configurations in the implementation of circuits including components requiring encapsulation.

The invention therefore provides an improvement to the method already described in the aforementioned patent document.

For this, such a circuit is notable in that at least one connection passage is provided in order to connect said first connection means to the outside of said lid.

Thus, the invention enables connections between the component positioned under the lid and the outside world, through the lid. This very often significantly simplifies the establishment of circuit connections.

The following description accompanied by the appended drawings, all provided as non-limiting examples, will make it possible to understand how the invention can be produced. In the drawings:

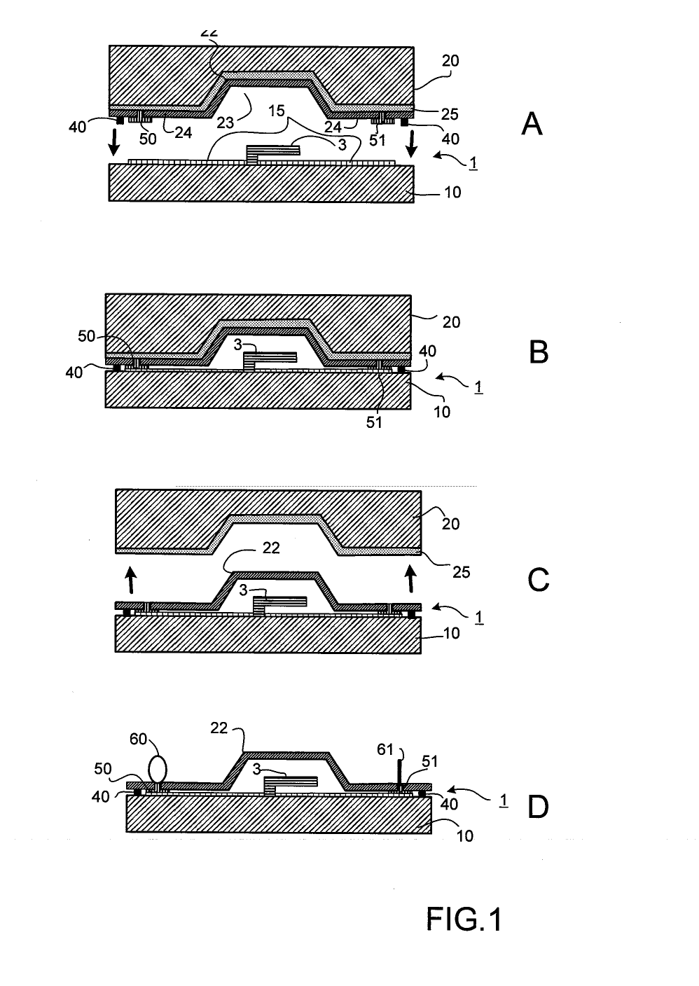

FIG. 1 shows the production of a microcircuit according to the invention,

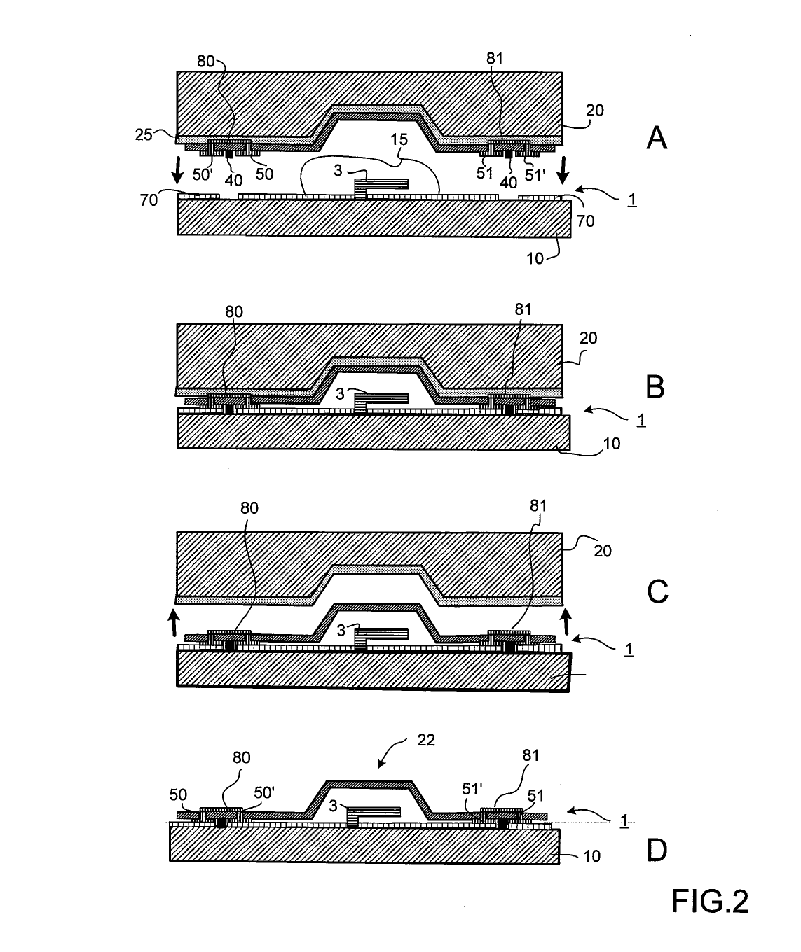

FIG. 2 shows the production of a microcircuit according to an alternative of the invention,

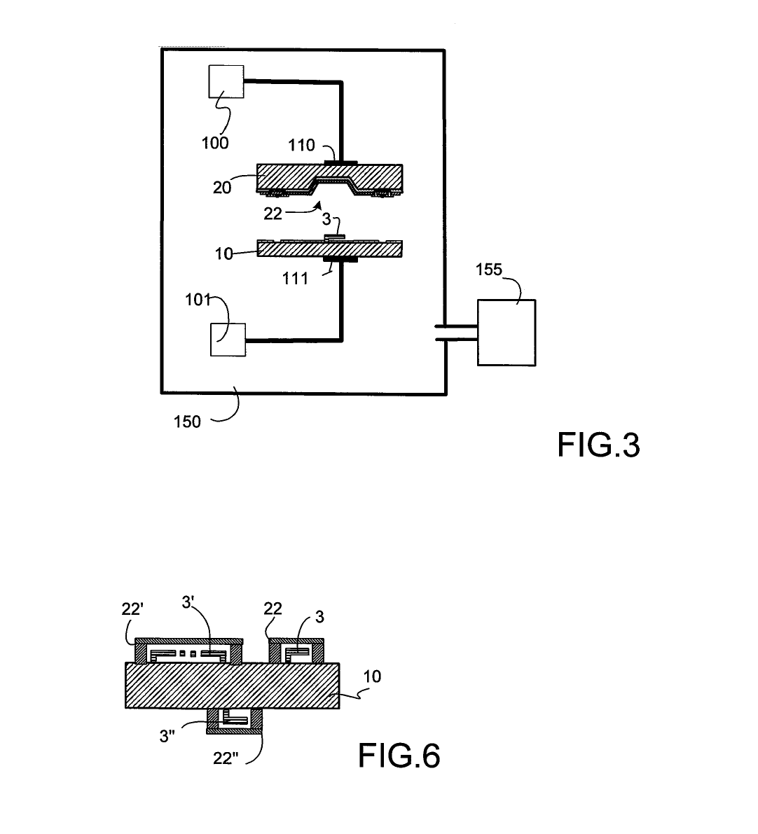

FIG. 3 is a diagram of a device for implementing said method,

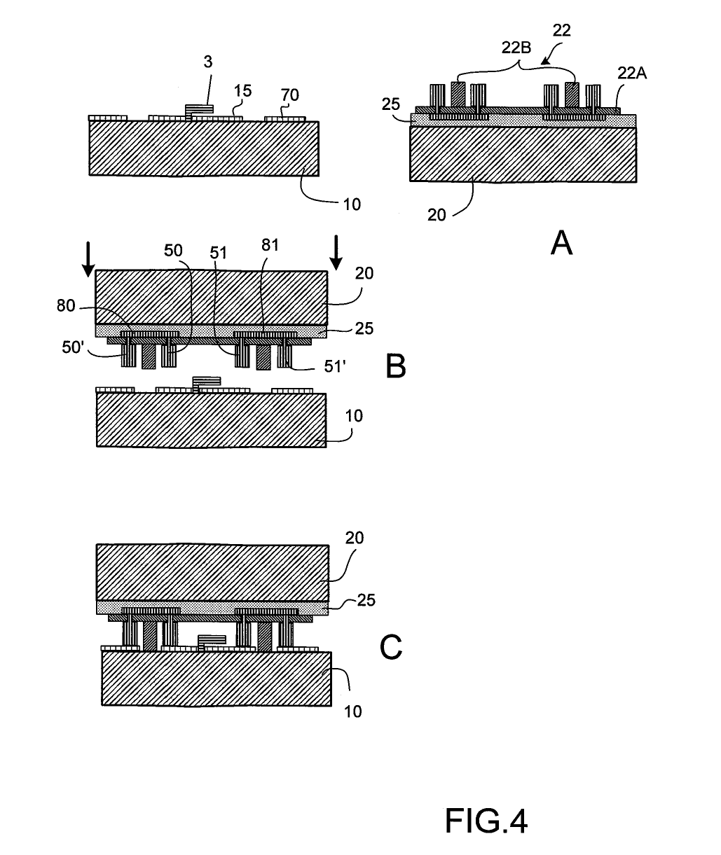

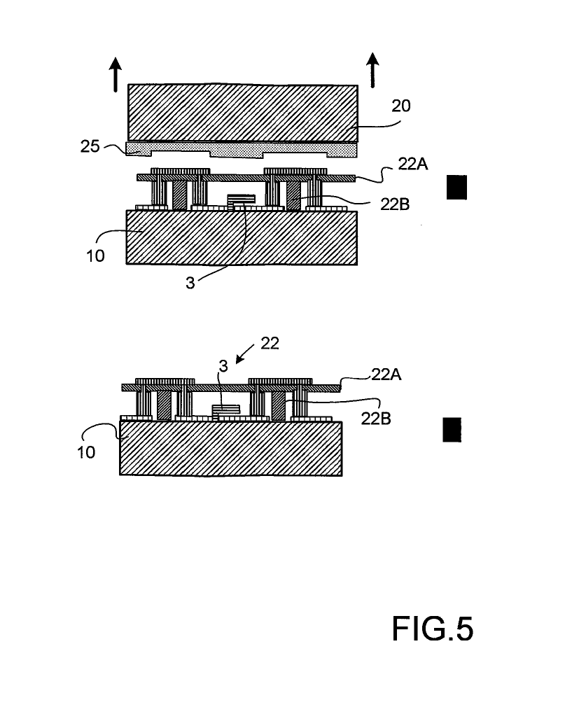

FIGS. 4 and 5 illustrate the production of a microcircuit according to another alternative of the invention,

FIG. 6 shows a circuit comprising, on the two faces of the substrate, a lid.

In these figures, the same elements are designated by the same reference signs in all of the figures.

In FIG. 1, reference 1 indicates a microcircuit comprising an electronic component 3 such as a temperature probe or an electret microphone arranged on a receiving substrate 10, needing to be protected from external stresses or to be insulated so as to be placed in a controlled environment. Linked to this component 3 are first connection means 15, fastened onto the receiving substrate 10. Reference 20 shows a substrate called a “mold” substrate, which contains the lid 22. In this described example, the lid comprises a hollow portion 23 for covering the microcircuit 1 and a corolla 24 arranged on the periphery of this portion 23. A layer 25 called a controlled adhesion layer is inserted between the lid 22 and the substrate 20, as is shown in A and B. A weld bead 40 is placed on the corolla 24 surrounding the portion 23 for the attachment of the latter on the substrate 10.

According to an aspect of the invention, connection passages are provided, formed in particular by means of metallization rivets 50 and 51, or VIAs that pass through the lid 22. These rivets will make contact with the connections 15 after the welding (see FIG. 1 in C and D).

FIG. 1 shows, in A, substrates 10 and 20 separated.

In B, the two substrates 10 and 20 are pressed one against the other and the weld bead is heated so that the lid 22 will be properly attached on the substrate 10.

In C, the separation of the two substrates 10 and 20 is illustrated. This operation is performed by carefully using the properties of the layer 25 so that the mold can easily be detached from the lid 22.

In D, the circuit is completed. The two rivets 50 and 51 lead to the outside and thus form a passage to the outside. This is then used to advantage in order to attach either a connection pad 60 (bump) or a connection wire 61 there.

Details on these molding and mold removal operations can be found by referring to the aforementioned patent document.

The concept of the invention can be used to advantage to produce interconnections on the microcircuit with the element 3 placed under a lid. This is shown in FIG. 2.

As is shown in A, the element 3 comprises first connection means 15 that need to be connected to second connection means 70 forming part of the rest of the circuit 1. For this, at the corolla 24 of the lid 22, connection passages are provided, which consist of metalized rivets 50 and 50′, on the one hand, and rivets 51 and 51′, on the other hand, respectively placed on each side of the weld bead 40. Connection bridges 80 and 81 arranged on the top of the corolla 24 of the lid 22 respectively connect the rivets 50 and 50′ and the rivets 51 and 51′. Electrical connections between the connections 15 and 70 are ensured. As in FIG. 1, the two substrates and the weld beads 40 are heated and pressed one against the other, as is shown in B of FIG. 2, to ensure mechanical contact between the two substrates. In C, the “mold” substrate is removed, enabling the layer 24 to be detached from the lid 22. In D, the finished circuit 1 equipped with the lid 22 is shown with the connections passing through it.

The encapsulation method is based on what has been explained above. In other words, this method therefore comprises the following steps:
arrangement on a substrate 10 of elements of said circuit of which at least one requires a lid,
creation of a mold 20 on which said lid is inserted with said connection passages and with said weld bead 40. An intermediate layer 24 placed between the lid 22 and the mold substrate 20 ensures that this lid is held in place and also enables it to be detached when the lid will be welded to the substrate 10.
placement of said mold 20 opposite said substrate 10,
melting of said bead 40,
separation of said mold from said substrate in order to obtain the circuit 1.

FIG. 3 shows a device for implementing the method. Again, reference can be made to the aforementioned patent document WO 2010/012966.

This FIG. 3 shows the two substrates 10 and 20 linked to power-operated plates 100 and 101 enabling movements in three orthogonal axes. The substrates 10 and 20 are held in place by holding means 110 and 111. All of this is placed in a chamber 150 in which a vacuum can be created by means of a vacuum pump 155. There will thus be a vacuum inside the lid 22.

According to this method, it is also possible to provide lids filled with a given gas such as nitrogen, etc. The vacuum pump is then replaced by means, such as bottles, intended to provide the required gas in the chamber 150. It is therefore possible to obtain a well-defined gas or vacuum atmosphere inside the lid 22.

The lids described above, comprising a corolla, are considered to be lids of a first type. However, they may have shapes different from that indicated above. FIGS. 4 and 5 show the application of the invention to other lid types.

FIG. 4 shows the first steps of the production of a circuit comprising components covered with a lid 22 formed by a plate 22A resting on a wall forming a cylinder 22B around the component 3. This lid is considered to be of the second type. In A, in this figure, the lid is attached on the mold substrate 20 as already described. In B, the substrates are placed opposite one another so as to be pressed one against the other. In C, the weld is performed by using, at least partially, wall 22B as a weld beam. FIG. 5 shows, in D, the separation of the two substrates 10 and 20, with the lid being detached from the substrate 20 owing to the properties of the layer 25 already described. E shows the circuit thus produced.

In FIGS. 4 and 5, the passages through the lid 22A, 22B are produced by means of VIAs designated by reference signs 50 and 50′, on the one hand, and 51 and 51′, on the other hand. The connection passages 50 and 50′ formed by VIAs are linked externally by a connection bridge 80 and the connection passages 51 and 51′ are linked by another bridge 81. Thus, the electrical connections between the connections 15 and 70 are ensured.

The advantage of this embodiment is that the surface occupied is reduced since there is no longer a corolla.

It should be noted that the invention applies to the case in which the components to which a lid has been added can be located on both faces of the substrate as shown in FIG. 6.

In this figure, the substrate 10 comprises, on one face, components 3 and 3′ to which lids 22 and 22′ are respectively added. On the other face of the substrate 10, a component 3″ is also attached, and is covered with a lid 22″.

It should be noted that the alignments performed automatically can be performed using hydrophilic and hydrophobic surfaces. Magnet-based systems can also be envisaged.

It should also be noted that, without going beyond the scope of the invention, the lid can be insulating or conductive. It is also possible to provide an insulating layer on the attachment edge of a conductive lid so as to insulate the rest of the circuit.

1. Electronic circuit consisting of a substrate (10) with at least one face on which at least one component (3) is mounted with which first connection means (15) are linked, and at least one lid (22) having a thin structure resting on said substrate (10) in order to cover said component (3), characterized in that at least one connection passage (50) is provided in order to connect said first connection means (15) outside said lid (22).

2. Electronic circuit according to claim 1, comprising second connection means (70) located outside said lid, characterized in that electrical connections (50, 50′, 51, 51′, 80, 81) are provided for connecting said first connection means (15) with second connection means (70) by passing through said lid (22) using said connection passages.

3. Electronic circuit according to claim 1 or 2, characterized in that the connection passages (50, 50′, 51, 51′) are formed by the connection passages constituted by metalized rivets (50, 50′, 51, 51′).

4. Electronic circuit according to claim 1, characterized in that a lid of a first type is provided for certain components, formed by a hollow portion (23) in order to surround said component, and a corolla (24) surrounding said hollow portion and resting on said substrate.

5. Electronic circuit according to claim 1, characterized in that it comprises a lid of a second type for other components formed by a plate (22A) comprising a wall (22B) resting on said substrate (10).

6. Electronic circuit according to claim 4, for which the lid (22) is attached to said substrate by means of a weld bead (40) placed between the corolla (24) and the substrate (10), characterized in that, to produce an electrical connection in order to connect the first (15) and second connection means (70), arranged on the corolla (24), on each side of the weld bead (40), are a first passage connection formed by a metalized rivet (50, 51) at the first connection means (15), and a second passage connection formed by a metalized rivet (50′, 51′) at the second connection means (70), and in that said electrical connection comprises connection bridges (80, 81) connecting the first and second passage connections.

7. Electronic circuit according to claim 5, characterized in that said wall (22B) at least partially forms a weld bead and in that, to produce an electrical connection in order to connect the first and second connection means, arranged on the corolla (24), on each side of the weld bead (40), are a first passage connection formed by a metalized rivet (50, 51) at the first connection means (15), and a second passage connection formed by a metalized rivet (50′, 51′) at the second connection means (70), and in that said electrical connection comprises connection bridges (80, 81) connecting the first and second passage connections.

8. Electronic circuit according to claim 1, characterized in that lids can be arranged on both faces of said substrate.

9. Method for producing a circuit according to claim 6, characterized in that it comprises the following steps:
arranging, on a substrate, elements (3) of said circuit, of which at least one requires a lid (22),
creating a mold (20) on which said lid (22) is inserted with said connection passages (50, 51) and with said weld bead (40),
placing said mold opposite said substrate,
melting said bead,
separating said mold from said substrate.

10. Device for applying said method according to claim 9, characterized in that it comprises a chamber (150) in which said method is applied, and an atmosphere device (155) for creating the required atmosphere inside said chamber.

11. Method for producing a circuit according claim 7, characterized in that it comprises the following steps:
arranging, on a substrate, elements (3) of said circuit, of which at least one requires a lid (22),
creating a mold (20) on which said lid (22) is inserted with said connection passages (50, 51) and with said weld bead (40),
placing said mold opposite said substrate,
melting said bead,
separating said mold from said substrate.

12. Device for applying said method according to claim 11, characterized in that it comprises a chamber (150) in which said method is applied, and an atmosphere device (155) for creating the required atmosphere inside said chamber.
